(19) United States
(12) Patent Application Publication
(10) Pub. No.: US 2017/0273858 A1
(43) Pub. Date: Sep. 28, 2017

(54) Method and Apparatus for Affecting Wellness Through Topical Application of Hand-held Rods

(71) Applicant: Lyndy Ngu, Westminister, CA (US)

(72) Inventor: Lyndy Ngu, Westminister, CA (US)

(21) Appl. No.: 15/080,318

(22) Filed: Mar. 24, 2016

(51) Int. Cl. A61H 15/00; A61H 1/00

(52) U.S. Cl. CPC A61H 15/0092; A61H 1/008; A61H 2201/0207; A61H 2201/0214; A61H 2201/1604; A61H 2201/1609; A61H 2201/1614

(57) ABSTRACT

A method and apparatus for affecting wellness in a person's body are provided. More particularly, the apparatus for affecting wellness comprises one, or even two, cylindrical rods comprising minerals and other materials defined, in some embodiments, by high specific heat and low conductivity so that the rods are able transfer heat to a person's body relatively slowly. Methods are disclosed which direct particular applications of such rods, or wands, on the body in order to locally stimulate muscles and circulation to relieve and/or treat various conditions.

### GOVERNMENT CONTRACT

Not applicable.

### CROSS-REFERENCE TO RELATED APPLICATIONS

Not applicable.

### STATEMENT RE. FEDERALLY SPONSORED RESEARCH/DEVELOPMENT

Not applicable.

### COPYRIGHT & TRADEMARK NOTICES

A portion of the disclosure of this patent document may contain material that is subject to copyright protection. This patent document may show and/or describe matter that is or may become trade dress of the owner. The copyright and trade dress owner has no objection to the facsimile reproduction by any one of the patent document or the patent disclosure, as it appears in the Patent and Trademark Office patent files or records, but otherwise reserves all copyrights and trade dress rights whatsoever.

### TECHNICAL FIELD

The disclosed subject matter relates generally to massage therapy, and more particularly, to methods and apparatuses for topically and thermo-therapeutically manipulating soft tissues in prescribed manners to promote wellness in the body.

### BACKGROUND

Massage is sometimes sought or prescribed in an effort to relieve muscle and joint pain, assist with blood circulation and lymph drainage, reduce muscle tension, and relieve other conditions such as headache, sinus, and even arthritis pain. Various cultures have also developed treatment methods involving applying localized pressure on points, called pressure points. Through this method, a practitioner or affected individual may apply concentrated pressure, such as by hand, elbow, or various devices to predetermined portions of the body to aid healing, wellness, and beauty.

For instance, U.S. Pat. No. 6,007,503 to Berger et al. teaches an anti-nausea acupressure device formed as a button adherable to the skin at a desired acupressure point; U.S. Pat. Pub. No. 2013/0123676 filed by Fallstich discloses a self massaging device comprising semi-compressable balls that are rotatable near and down the length of a user's spinal column; and U.S. Pat. Pub. No. 2007/0270727 filed by Zadeh teaches methods and devices for applying continuous pressure at predetermined pressure points to affect therapy. These proposals are deficient, however, because their utility is limited to particular applications by their form. Indeed, at least with respect to Berger and Fallstich application is limited to a static pressure point and a person's back respectively. With respect to Zadeh, self-therapy using the device requires a fixed frame, making the device unwieldy and difficult to transport.

Sometimes, thermally conductive implements are used to aid therapeutic effects of massage discussed above. For example, U.S. Pat. No. 5,094,238 to Gibbon discloses a heating pad that is moldable to portions of the body for applying heat or cooling to localized areas having pain; Intl. Pat. App. WO2010/112915 to McWilliams discloses a device for transferring heat or cooling massage tools; and U.S. Pat. No. 8,715,210 issued to Orlando discloses mateable portions of a partially conductive, self heating massage stone having heating elements arranged within recessed portions defined by mateable ovals. Still, these proposals are insufficient for affecting wellness through topical application because their form is not well suited to self-treatment and highly localizable pressure applications.

Although various proposals have been made to solve the problem, none of those in existence combine the characteristics of the present invention. Therefore, there is a need for devices, systems and methods of affecting wellness in the body via means that are compact and manipulable by oneself to permit, in some instances, self-treatment.

### SUMMARY

The present disclosure is directed to methods and apparatuses that enable external and localized manipulation of nerves and pressure points in a person's body to thermo-therapeutically enhance wellness and beauty, as well as relieve various uncomfortable conditions in the person's body, by enhancing blood and lymph circulation.

For purposes of summarizing, certain aspects, advantages, and novel features have been described. It is to be understood that not all such advantages may be achieved in accordance with any one particular embodiment. Thus, the disclosed subject matter may be embodied or carried out in a manner that achieves or optimizes one advantage or group of advantages without achieving all advantages as may be taught or suggested.

In an embodiment, one or more rods, or wands, are provided to enable the method for affecting wellness in a person's body. Such rods may be formed as rigid, hand-holdable cylinders defined by a smooth side portion spaced apart by round top and bottom ends. In some embodiments, the top and bottom ends may be convex to ensure comfortable application of the rods to prescribed regions of a person's body.

It is contemplated that the rods may be defined by any dimensional size or weight that is hand-holdable and manipulable by a person to affect wellness in his or herself, or in another person. Thus, self-application is contemplated but does not limit the invention.

The rods may be used by a person to affect wellness by applying one or more of the rods under pressure to his or herself or another person. More particularly, the rods may be applied in conjunction with or at certain sensitive bodily pressure points, which may be known to those skilled in the art. Several particular methods of applying the rods to the body are herein described, though it should be understood that other applications are contemplated and will be recognized as embodied in the disclosure by those skilled in the art.

In one embodiment of the method, a person may grip one each of the at least one rigid rods by hand and, with pressure, applying at least one of the rigid rods to one or more predetermined portions of his own or another person's body. More particularly, the step of applying the rigid rods may comprise placing, under pressure, the side portion corresponding to the top end of the first rod against an outside of a person's left nostril and that of a second rod against an outside of the person's right nostril to prevent air flow therethrough for a predetermined length of time. Then, the person may press the side portions of each first and second rods upward against respective sides of the person's nose toward the person's left and right brow bones. One skilled in the art will recognize that this portion of a person's face roughly corresponds to his or her sinuses, which are air cavities connected to the nose. Massaging this region in this manner, then, may stimulate blood and other fluid circulation that help relieve discomfort caused by inflamed or clogged sinuses.

In some embodiments, the rods may be optionally heated or cooled to further aid application and ultimate wellness derived from use of the wands. Indeed, in some embodiments, the rods, or wands, may comprise material defined by certain thermal characteristics. For instance, it may be preferable to apply one or more rods having high specific heat capacity and low conductivity to portions of the body so that the rod(s) disperse heat relatively slowly, or in other words at a rate that the subjected person may be able to comfortably absorb and adjust to. Providing rods defined by such characteristics may ensure that application of the rods according to the disclosed methods may favorably optimize blood flow and cell function. Materials contemplated include basalt, quartz, agate, and marble, although one skilled in the art will recognize that other materials, such as ceramic, are also available to practice the invention. Indeed, some materials, or even combinations of materials, may be chosen to comprise the rods depending on whether a person alternatively desires cold or hot application of the rods to the body.

Other embodiments of methods for applying the rods to a person's body may comprise, for example and without limitation, pressing at least some of the side portion of one each of the rigid rods near a center region of a person's face and symmetrically pulling each rod toward an outer region of the person's face. Such application may, depending on the particular points of external application, aid wellness, relief, and/or recovery related to bleeding nose, hayfever, sinus discomfort, cataracts, dry or lazy or swollen eyes, skintone, and even paralyzed muscles.

As another example, an embodiment of the method for applying the rods to a person's body may comprise pressing the side portion of at least one rod against the person's forehead between the person's eyebrows and pressing the at least one rod upward toward the person's hairline and repeating this upward motion across the width of the person's forehead.

As yet another example, an embodiment of the method for applying the rods to a person's body may comprise pressing the side portion of a rod against an underside of a person's ear for a predetermined length of time. In some embodiments, the method may further comprise pressing the side portion of another rod against a front side of the person's ear such that the another rod obscures the person's ear canal. Such application may relieve headaches and dizziness.

As still another example, an embodiment of the method for applying the rods to a person's body may comprise pressing the side portion of at least one rod into a back side of a person's neck at a base of the person's hairline, and pressing the at least one rod downward toward the person's shoulders. Such application may aid wellness, relief, and/or recovery related to migraines and/or stiff necks and even help a subjected person with sleeping.

Of course, many other methods of externally applying the rods to a person's body, either by him or her self or by another person, are contemplated. The foregoing are offered by way of example only, and not of limitation. Indeed, systematically applying the wands to different portions of the body, for different periods of time, and even under optionally heated or cool states may positively affect wellness and even relieve discomfort from various conditions.

Thus, it is an object of the invention to provide a compact, hand-holdable tool to aid localized and external stimulation of various sensitive portions of a person's body.

It is another object of the invention to enable self-stimulation of various sensitive portions of a person's body to enhance blood and other fluid circulation.

It is yet another object of the invention to provide a device which therapeutically transfers either heat or cold to a localized region of a person's body to affect wellness therein.

One or more of the above-disclosed embodiments, in addition to certain alternatives, are provided in further detail below with reference to the attached figures. The disclosed subject matter is not, however, limited to any particular embodiment disclosed.

### BRIEF DESCRIPTION OF THE DRAWINGS

FIG. 1 illustrates a method of massage therapy in accordance with one embodiment in which an embodiment of cylindrical rods is applied to the sides of a person's nose.

FIG. 2 illustrates the method of massage therapy in accordance with another embodiment in which an embodiment of the cylindrical rods is applied outward from a various central portions of a person's face.

FIG. 3 illustrates the method of massage therapy in accordance with still another embodiment in which an embodiment of the cylindrical rods is applied upward and successively across the width of a person's forehead.

FIG. 4 illustrates the method of massage therapy in accordance with yet another embodiment in which an embodiment of the cylindrical rods is applied along a person's neck.

FIG. 5 illustrates the method of massage therapy in accordance with another embodiment in which an embodiment of the cylindrical rods is applied to opposing sides of a person's ear.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein.

### DETAILED DESCRIPTION

Having summarized various aspects of the present disclosure, reference will now be made in detail to that which is illustrated in the drawings. While the disclosure will be described in connection with these drawings, there is no intent to limit it to the embodiment or embodiments disclosed herein. Rather, the intent is to cover all alternatives, modifications and equivalents included within the spirit and scope of the disclosure as defined by the appended claims.

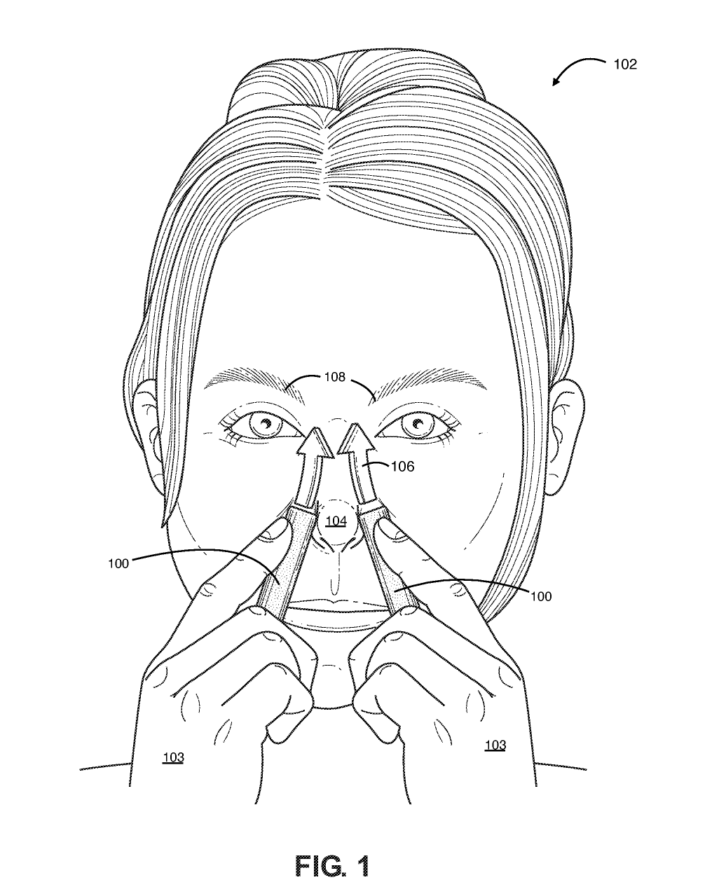

Exemplary methods of applying the means for affecting wellness in the body via means that are compact and manipulable by oneself to permit, in some instances, self-application embodying aspects of the invention are shown in FIGS. 1 through 5. It will be understood that the invention is not limited to the methods illustrated, though. Rather, the methods have been selected to demonstrate to those skilled in the art the variety of methods contemplated for localized and external thermo-therapeutic treatment using such means, so that they can better understand the invention and be able to create or enable additional methods. It should also be understood that the drawings are not exact replications of various any one method, but are only provided to illustrate the approximate motions effecting the methods associated with the thermo-treatments to that the methods may be better understood.

FIG. 1 illustrates one embodiment of the method for affecting wellness. In particular, the method may comprise two hand held rods 100, or wands, which a person 102, such as the subject of the massage therapy or even therapist or other third party, may apply with pressure by hand to seal the person's nostrils on either side of her nose 104. Then, following the direction of arrows 106, the person may press the rods 100 upward against respective sides of the person's nose 104 toward each of the person's brow bones 108. One skilled in the art will recognize that this portion of a person's face roughly corresponds to his or her sinuses, which are air cavities connected to the nose. Rubbing, or massaging, this region in this manner, then, may stimulate blood and other fluid circulation that help relieve discomfort caused by inflamed or clogged sinuses.

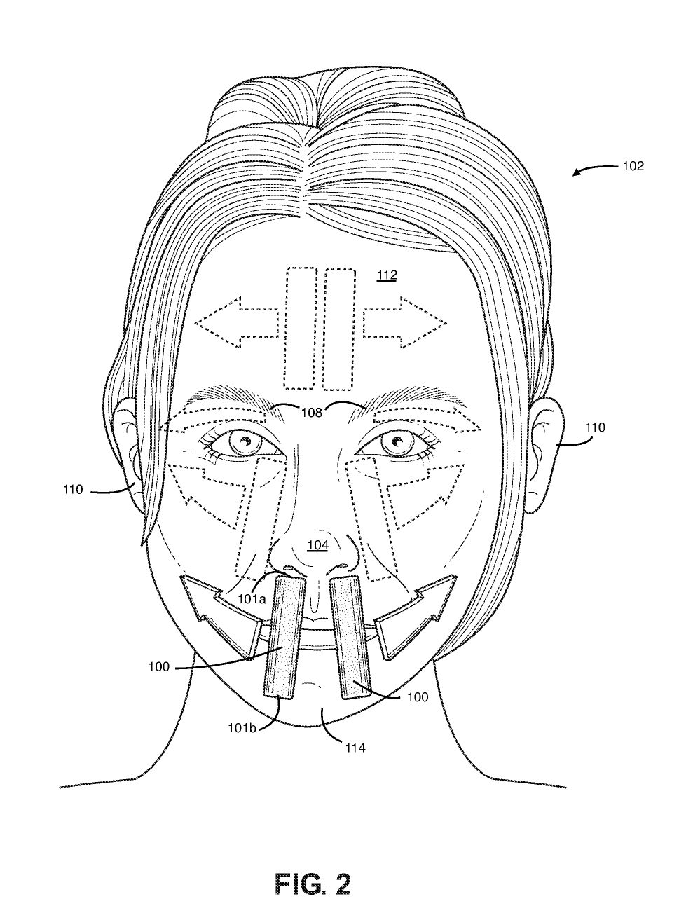

FIG. 2 illustrates another method for affecting wellness in which one or more rods 100 may be pressed against a center portion of a person's 102 face, such as beneath his or her nose 104 and then rubbed symmetrically toward an outer portion of the person's face.

Though hands have been removed from the figure, it should be understood that a person treating his or herself or another may hold the rods, or wands, by hand in order to practice the invention. Here, though, the rods 100 are unobscured so as to provide a clearer view of an embodiment of such rods 100. In particular, such rods may be formed as rigid, hand-holdable cylinders defined by a smooth side portion spaced apart by round, top and bottom ends 101a, 101b. In some embodiments, the top and bottom ends 101a, 101b may be convex to ensure comfortable application of the rods to prescribed regions of a person's body.

It is contemplated that the rods 100 may be defined by any dimensional size or weight that is hand-holdable and manipulable by a person to affect wellness in his or herself, or for another person, such as a by a physical or massage therapist. In some embodiments, the rods 100 may be about 1.50 inches to about 6 inches in length. The rods 100 may be about 0.25 to about 1 inches in diameter.

Additionally, it is contemplated that the rods 100 may be optionally heated or cooled to further aid application and ultimate wellness derived from use of the wands, as those skilled in the art will know that applying heat or cold to a region of the body may aid circulation and/or relieve pain and other conditions related to wellness. In some embodiments then, the rods 100, or wands, may comprise material defined by certain thermal characteristics. For instance, it may be preferable to apply one or more rods having high specific heat capacity and low conductivity to portions of the body so that the rod(s) disperse heat relatively slowly, or in other words at a rate that the subjected person may be able to comfortably absorb and adjust to. Providing rods defined by such characteristics may ensure that application of the rods according to the disclosed methods may favorably optimize blood flow and cell function. Materials contemplated include basalt, quartz, agate, and marble, although one skilled in the art will recognize that other materials, such as ceramic, are also available to practice the invention. Indeed, some materials, or even combinations of materials, may be chosen to comprise the rods depending on whether a person alternatively desires cold or hot application of the rods to the body. Some materials, or even combinations of materials, may even be chosen based on the various textures such materials may comprise. For instance, rougher materials may aid exfoliation and wellness related to skin tone, while smoother materials may provide more even distribution of thermal benefits.

In order to change the temperature of the rods, or wands, prior to application to prescribed regions of a person's body, the rods 100 may be submerged in, optionally, hot or cold water. Thus for instance, the rods 100 may be placed into water that has been heated to a desirable temperature, then removed from such water, dried off, and then applied to prescribed regions of a person's body. Likewise, the rods 100 may be submerged into water that has been substantially cooled, such as with ice or refrigeration, then removed from such water, dried off, and then applied to prescribed regions of a person's body. It should be noted that room temperature application of the rods 100 is also contemplated. Indeed, repeated rubbing, or massage, over a person's body may naturally transfer at least some heat to the rods 100 though friction.

In some embodiments, it nay be preferable to repeat the prescribed method(s) for a certain length of time, a certain number of times, or even until the rods 100, or wands, have reached room temperature. This may prevent overstimulation of treated areas.

Thus, returning attention to the methods illustrated in FIG. 2, a side portion of optionally hot or cold rods 100 may be placed beneath a person's 102 nose 104, such as in the space known in art as a philtrum, and then rubbed outward toward the person's ears 110. This may relieve, treat, or other wise affect wellness with regards to bleeding nose, hay fever, and/or sinus problems, and may also relieve flu-like symptoms. In some embodiments, it may be preferred to apply heated rods 100 in this manner. In still other embodiments, it may be preferred to hold at least one of the rods 100 for several seconds beneath the person's 102 nose 104 before rubbing the side portions of the rods 100 outward toward the person's 102 ears 110.

This outward rubbing along a person's face may be performed along other prescribed regions. For instance, the side portion of a rod 100 may be held beneath one each of a person's 102 eyes 112 along the sides of his or her nose 104. Then the rods 110 may be pulled, dragged, or rolled along the lower eyelid and/or cheekbone toward the person's 102 ears 110. This method may be repeated until the rods 100 are cooled and may affect wellness related cataracts, dry eyes, lazy eyes, and/or swollen eyes.

As another possible embodiment of the method depicted in FIG. 2, one each of the rods 100 may be held under a person's 102 eyebrows 108 and pulled toward his or her ears 110 to brighten eyes and/or tighten eye area. This too may be repeated until heated rods 100 are cooled, or even until cool rods 100 become warmed to room or skin temperature.

Similar outward motions may be performed rubbing, pulling, or even rolling the side portions of one or more rods 100 outward across the person's 102 forehead 112 and even chin 114 to aid wellness related to skintone, paralyzed muscles, and the appearance of scars.

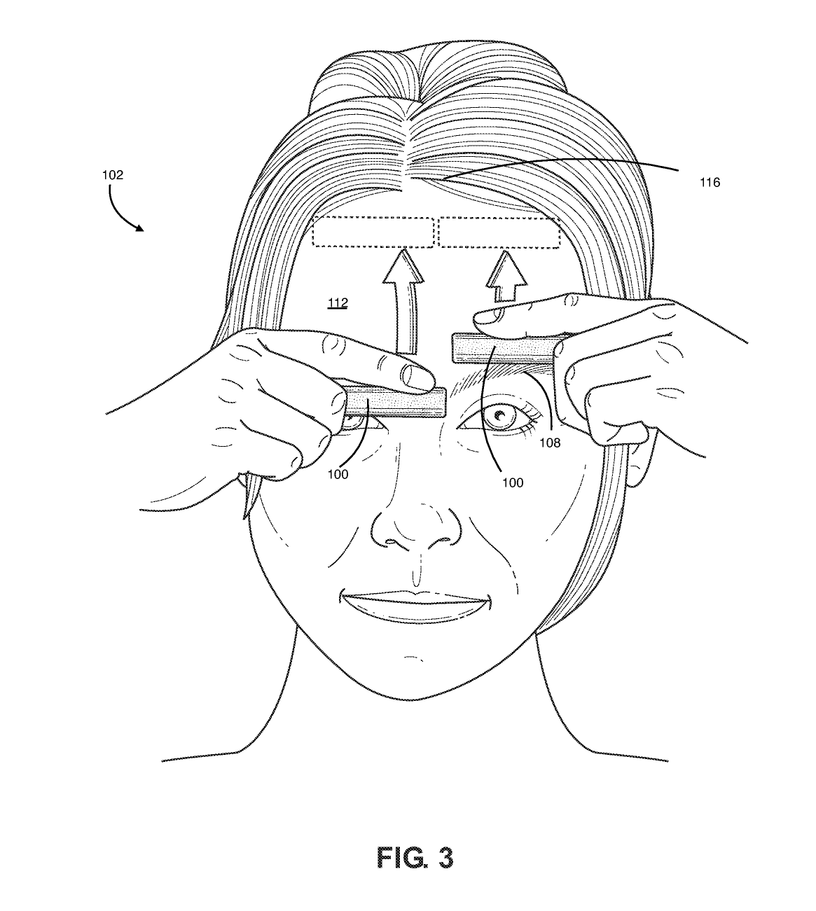

With reference to FIG. 3 it may be seen that vertical, or upward, application of one or more rods 100 is also contemplated. Thus, in one embodiment of the method for affecting wellness, a person may use his or her hands 103 to pull, push, drag, or roll one or more rods upward from his or her or another person's 102 eyebrows 108 to hairline 116 across the width of his or her forehead 112. This may affect wellness with respect to wrinkles on headaches, and/or flu relief.

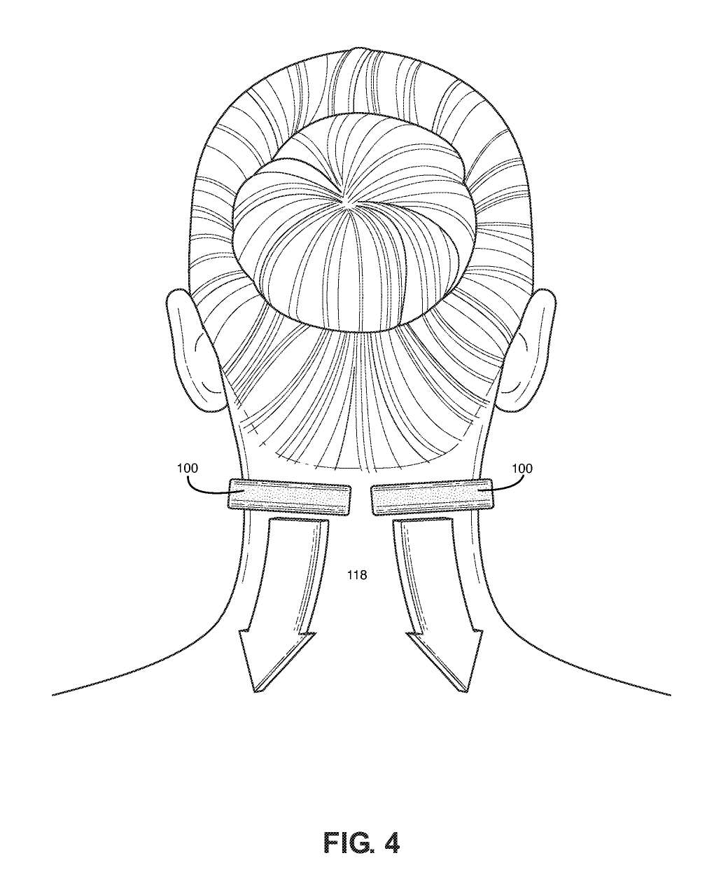

FIG. 4 illustrates an embodiment of the method for affecting wellness in which a person may rub, pull, or roll one or more of the rods 100 to the back side of his or her or another person's 102 neck 118 from his or her or the other person's hairline 116 toward his, her or the other person's shoulders 120. This method may serve, in particular, to support wellness by relieving migraines, stiff necks, and sleeping.

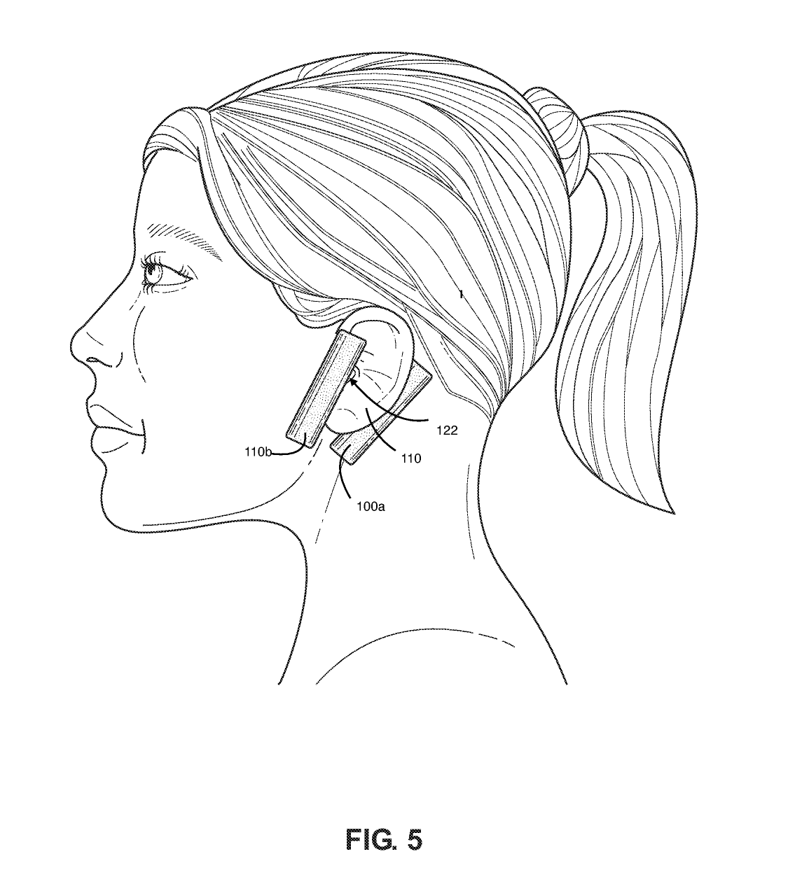

FIG. 5 illustrates an embodiment of the method for affecting wellness in which a person may treat and/or relieve dizziness and/or headache by pressing the side portion of a rod 100a behind a person's 102 ear. It may be held in such position for a period of about pressure point also linked to the spine. Place wand vertically along ear and roll ear over the wand. Hold for 30 seconds or until the rod 100a cools. The rod 100a may be reheated and the pressured application may be repeated. Additional rods may be applied in accordance with this method. For example, in some embodiments, one rod 100b may be placed in front of the ear 110 in line or overlapping with a person's ear canal 122, while one rod 100a may be placed behind the ear 110 for a period of time, such as about 30 to about 90 seconds, to treat and/or relieve headaches and/or dizziness.

Other embodiments of the method for affecting wellness through topical applications of the embodiment of the apparatus described are contemplated. Such additional embodiments do not appear in the drawings for the sake of brevity, however, one skilled in the art will find the methods sufficiently enabled by the foregoing disclosure. For instance, in one such embodiment, the method may comprise holding one or more heated rods, or wands, under pressure at the crown of a person's head until the one or more rods are cooled. It is contemplated that such method may relieve high blood pressure and headaches.

In another embodiment, the method for affecting wellness may comprise repeatedly rubbing or rolling one or more rods downward along the anterior side of the neck and, more particularly, along each vertical side of a person's esophagus. Such method may be practiced to treat and/or relieve asthma, phlegm and mucous, difficulty breathing, dry mouth, and maladapted thyroid. In still another embodiment, a person may simply hold one or more rods under pressure at the base of his or her or another person's throat for about 30 seconds to about 90 seconds to treat and/or relieve or otherwise affect wellness relating to breathing problems. In the event that rods are heated or cooled to perform this, or any, method, the one or more rods may be reheated or recooled, as the case may be, before repeating the method.

In yet another embodiment, wellness in various joints on the body may be affected by applying the rods according to various methods. For instance, in one embodiment, one or more rods may be pressed into the space behind a person's knee—colloquially known as a knee pit—then, with the person articulating their knee joint by repeatedly bending and unbending the knee, another rod or rods may be rolled or rubbed along the front side of the knee. This may treat and/or relieve arthritis pain and discomfort associated with tight knee joints and muscles. Similarly, a rod or rods may be held under pressure against the back side of a person's shoulder. Then, with the person articulating from his or her shoulder joint, another rod or rods may be rolled along the front and top portions of the shoulder to treat and/or relieve shoulder joint pain and discomfort associated with tight shoulder joints and muscles.

In one embodiment, an end of one each of the rods may be held under pressure in a person's ears to cover the person's ear canals for a period of time, such as about one minute. Then, the rods may be simultaneously pulled out of the ears, possibly causing the person to experience a popping sound or sensation in his or her ears. It is contemplated that such a method may be practiced to affect wellness relating to tinnitus—or ringing ears—fatigue, and high blood pressure.

Other possible embodiments of the method for affecting wellness may include: rolling or rubbing one or more rods back and forth across upper chest area to treat heart and breathing discomfort and other conditions; rubbing or rolling one or more rods over scars, and rashes such as hives; rolling or rubbing one or more rods across the lower back to ease nerve pain and symptoms associated with calcification; rubbing or rolling one or more rods across the abdomen and/or lower back to relieve or otherwise treat upset stomach, abdominal pain, nausea and/or shingles; rolling or rubbing one or more rods on or around portions of the legs, calf, and knee areas assist with circulation and muscle recovery; rolling or rubbing one or more rods across the length of the sole of the food to affect wellness with respect to circulation, energy, back pains and stomach pains; rolling or rubbing one or more rods over the wrist and forearm to relieve symptoms of carpal tunnel syndrome; rolling or rubbing one or more rods on the inner, outer, and back of the ankle to treat and/or relieve conditions associated with the stomach, sore ankles, and Achilles tendonitis.

Again, it should be understood that any of the aforementioned methods may be performed by the person subjected to any of the various treatments on his or her self, or alternatively, by another person, such as—for example and without limitation—a massage therapist or acupressure practitioner.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

### CONCLUSIONS, RAMIFICATIONS, AND SCOPE

While certain embodiments of the invention have been illustrated and described, various modifications are contemplated and can be made without departing from the spirit and scope of the invention. For example, the particular dimensions and weight of the rods may vary depending on the particular needs of the affected person. Additionally, the color may be chosen based on aesthetic or other considerations. Accordingly, it is intended that the invention not be limited, except as by the appended claim(s).

The teachings disclosed herein may be applied to other systems, and may not necessarily be limited to any described herein. The elements and acts of the various embodiments described above can be combined to provide further embodiments. All of the above patents and applications and other references, including any that may be listed in accompanying filing papers, are incorporated herein by reference. Aspects of the invention can be modified, if necessary, to employ the systems, functions and concepts of the various references described above to provide yet further embodiments of the invention.

Particular terminology used when describing certain features or aspects of the invention should not be taken to imply that the terminology is being refined herein to be restricted to any specific characteristics, features, or aspects of the method and apparatus for affecting wellness through topical application of hand-held rods with which that terminology is associated. In general, the terms used in the following claims should not be constructed to limit the method and apparatus for affecting wellness through topical application of hand-held rods to the specific embodiments disclosed in the specification unless the above description section explicitly define such terms. Accordingly, the actual scope encompasses not only the disclosed embodiments, but also all equivalent ways of practicing or implementing the disclosed system, method and apparatus. The above description of embodiments of method and apparatus for affecting wellness through topical application of hand-held rods is not intended to be exhaustive or limited to the precise form disclosed above or to a particular field of usage.

While specific embodiments of, and examples for the method, and apparatus are described above for illustrative purposes, various equivalent modifications are possible for which those skilled in the relevant art will recognize.

While certain aspects of the method and system disclosed are presented below in particular claim forms, various aspects of the method and apparatus are contemplated in any number of claim forms. Thus, the inventor reserves the right to add additional claims after filing the application to pursue such additional claim forms for other aspects of the method and apparatus for affecting wellness through topical application of hand-held rods.

What is claimed is:

1. A method for affecting wellness, comprising:
providing at least one rigid rod, the rod defined by a smooth and cylindrical side portion and a top end, and a bottom end, the side portion and top and bottom ends defining smooth, circular top and bottom edges;
optionally heating or cooling the at least one rod;
gripping one each of the at least one rigid rods by hand; and
applying at least one of the rigid rods to one or more predetermined portions of a person's body under pressure.

2. The method of claim 1, wherein the step of applying the rigid rods comprises:
placing, under pressure, the top edge of the first rod against an outside of a person's left nostril and a second rod against an outside of the person's right nostril to prevent air flow therethrough for a predetermined length of time; and
pressing the side portions of each first and second rods upward against respective sides of the person's nose toward the person's left and right brow bones.

3. The method of claim 1, wherein the step of applying the rigid rods comprises:
pressing at least some of the side portion of one each of the rigid rods near a center region of a person's face; and
symmetrically pulling each rod toward an outer region of the person's face.

4. The method of claim 3, wherein the center region of the person's face may be an upper edge of the person's cheekbones beneath each of the person's tear ducts, and the outer region of the person's face may be an upper end of each of the person's ears.

5. The method of claim 3, wherein the center region of the person's face may be an inner edge of the person's brow bones, and the outer region of the person's face may be an upper end of each of the person's ears.

6. The method of claim 3, wherein the center region of the person's face may be a person's philtrum, and the outer region of the person's face may be a lower end of each of the person's ears.

7. The method of claim 3, wherein the center region of the person's face may be a person's chin, and the outer region of the person's face may be left and right rear edges of a person's mandible.

8. The method of claim 1, wherein the step of applying the rigid rods comprises:
pressing the side portion of at least one rod against the person's forehead between the person's eyebrows and pressing the at least one rod upward toward the person's hairline; and
repeating the upward motion across the width of the person's forehead.

9. The method of claim 1, wherein the step of applying the rigid rods comprises:
pressing the side portion of a rod against an underside of a person's ear for a predetermined length of time.

10. The method of claim 9, further comprising pressing the side portion of another rod against a front side of the person's ear such that the another rod obscures the person's ear canal.

11. The method of claim 1, wherein the step of applying the rigid rods comprises:
pressing the side portion of at least one rod into a back side of a person's neck at a base of the person's hairline, and pressing the at least one rod downward toward the person's shoulders.

12. The method of claim 1, wherein the rods comprise minerals chosen from at one or a combination of basalt, quartz, agate, and marble.

13. A method for affecting wellness, comprising:
providing at least one rigid rod, the rod defined by a smooth and cylindrical side portion, a top end, and a bottom end, the side portion and ends defining smooth, circular top and bottom edges;
optionally heating or cooling the at least one rod;
gripping one each of the at least one rigid rods by hand; and
applying at least one of the rigid rods to one or more predetermined portions of a person's body under pressure according to one or more of the applications selected from the group of applications consisting of:
a) first pressing the top edge of the first rod against an outside of a person's left nostril and a second rod against an outside of the person's right nostril to prevent air flow therethrough for a predetermined length of time, and then pressing the side portions of each first and second rods upward against respective sides of the person's nose toward the person's left and right brow bones;
b) pressing at least some of the side portion of one each of the rigid rods near a center region of a person's face, and symmetrically pulling each rod toward an outer region of the person's face;
c) pressing the side portion of at least one rod against the person's forehead between the person's eyebrows and pressing the at least one rod upward toward the person's hairline, and repeating the upward motion across the width of the person's forehead;
d) pressing the side portion of a rod against an underside of a person's ear for a predetermined length of time; and
e) pressing the side portion of at least one rod into a back side of a person's neck at a base of the person's hairline, and pressing the at least one rod downward toward the person's shoulders.
